(19) United States
(12) Patent Application Publication
(10) Pub. No.: US 2013/0062916 A1
(43) Pub. Date: Mar. 14, 2013

(54) Vehicle Safety Seat Mechanical Shock Indicator

(71) Applicant: Robert D. Wiley, Princeton, MA (US)

(72) Inventor: Robert D. Wiley, Princeton, MA (US)

(73) Assignee: THE MAGNIFICENT 7 GROUP, INC., North Oxford, MA (US)

(21) Appl. No.: 13/606,485

(22) Filed: Sep. 7, 2012

Related U.S. Application Data
(60) Provisional application No. 61/532,654, filed on Sep. 9, 2011.

(51) Int. Cl. B60N 2/42; G01L 5/00; B23P 11/00; B60N 2/26

(52) U.S. Cl. 297/216.11; 116/203; 116/201; 29/428

(57) ABSTRACT

A vehicle safety seat with mechanical shock indication includes a safety seat body defining a seat region for a child during vehicle travel and a mechanical shock indicator assembly mounted to the safety seat body for indicating that the child vehicle safety seat has suffered a mechanical shock of a least a predetermined magnitude.

### CROSS-RELATION OF RELATED APPLICATION

This application claims benefit from U.S. Provisional Patent Application No. 61/532,654, filed on Sep. 9, 2011, the entire contents of which are hereby incorporated by reference.

### TECHNICAL FIELD

This disclosure relates to vehicle safety seats, and, more particularly, to infant and child vehicle safety seats with mechanical shock indicators.

### BACKGROUND

Vehicle safety seats, specifically designed and engineered for smaller passengers, e.g. infants and children, are now mandated equipment in many jurisdictions. Typically, these seats are removable, e.g. to allow transport of larger passengers, e.g. adults, and for replacement and upgrade in equipment as infant and child passengers grow. These vehicle safety seats are particularly designed to protect their passengers during vehicle collisions, or even during evasive maneuvers or panic stops to avoid collisions. Fortuitously, through use of mandated safety equipment, in many such instances, an occupant of a vehicle safety seat will often survive with little or no apparent injury. However, head trauma and other serious internal injuries, such as can often be suffered due to shock, i.e. rapid deceleration, e.g. as a result of collision and the like, is not always immediately apparent, even to trained and experience emergency medical technicians (“EMTs”) and other first arrivers at a vehicle accident.

### SUMMARY

According to one aspect of this disclosure, a vehicle safety seat with mechanical shock indication comprises a safety seat body defining a seat region for receiving and securely retaining a child during vehicle travel, and a mechanical shock indicator assembly mounted to the safety seat body for indication that the child vehicle safety seat has suffered a mechanical shock of a least a predetermined magnitude. The mechanical shock indicator assembly comprises an indicator body comprising a front body portion and a rear body portion, each of the body portions formed of molded plastic and defining a front surface and a rear surface of the indicator body, respectively. The front body portion and the rear body portion cooperatively define at least one recess sized for receiving a mechanical shock indicator in secure engagement therebetween. At least one mechanical shock indicator element is securely contained within the recess cooperatively defined by the front body portion and the rear body portion. The front body portion further defines a magnifier lens overlying the at least one mechanical shock indicator in the at least one recess, for facilitating assessment of the mechanical shock indicator for indication that the device has received a mechanical shock of at least the predetermined threshold magnitude.

Preferred implementations of this aspect of the disclosure may include one or more of the following additional features. The molded plastic forming the indicator body comprises acrylic. The predetermined magnitude of mechanical shock indicated by the at least one mechanical shock indicator is 50 G. The mechanical shock indicator assembly comprises at least two mechanical shock indicator elements, with the magnifier lens overlying the at least two mechanical shock indicator elements. The front body portion and the rear body portion cooperatively define at least two recesses, each recess containing a mechanical shock indicator element. The child vehicle safety seat further comprises one or more adhesive elements engaged between the rear surface of the indicator body and the safety seat body for mounting the mechanical shock indicator assembly upon the safety seat body.

According to another aspect of this disclosure, a mechanical shock indicator assembly for a vehicle safety seat comprises an indicator body comprising a front body portion and a rear body portion, each of the body portions formed of molded plastic and defining a front surface and a rear surface of the indicator body, respectively. The front body portion and the rear body portion cooperatively define at least one recess sized for receiving a mechanical shock indicator in secure engagement therebetween. At least one mechanical shock indicator element is securely contained within the recess cooperatively defined by the front body portion and the rear body portion. The front body portion further defines a magnifier lens overlying the at least one mechanical shock indicator in the at least one recess, for facilitating assessment of the mechanical shock indicator for indication the device having received a mechanical shock of at least the predetermined value. One or more mounting elements, e.g. one or more adhesive elements, are disposed for engagement between the rear surface of the indicator body and the safety seat body for mounting the mechanical shock indicator assembly upon the safety seat body. The one or more mounting elements comprise protective release elements removable to expose an adhesive surface.

According to another aspect of this disclosure, a method of assembling a mechanical shock indicator assembly for a vehicle safety seat comprises the steps of: providing a front indicator body portion and a rear indicator body portion, each of the body portions being formed of molded plastic, providing at least one mechanical shock indicator, assembling the body portions with the at least one mechanical shock indicator positioned in an appropriately-sized recess cooperatively defined by body portions, and securing the body portions together, with the mechanical shock indicator securely disposed within the at least one cooperatively sized recess, beneath a magnifier defined by the front body portion.

Preferred implementations of this aspect of the disclosure may include the following feature. The method of assembling a mechanical shock indicator assembly for a vehicle safety seat comprises the further step of mounting the mechanical shock indicator assembly upon a safety seat body of a vehicle safety seat.

According to still another aspect of this disclosure, a method of assessing a vehicle safety seat for indication of experience of a mechanical shock above a predetermined threshold comprises the steps of, following a traffic accident involving a vehicle with one or more occupants in vehicle safety seats, inspecting the vehicle child safety seats for a mechanical shock indicator assembly mounted upon a seat body of the vehicle child safety seat, and, upon locating the mechanical shock indicator assembly, inspecting an associated mechanical shock indicator through a magnifier lens disposed thereon for visual indication of a mechanical shock above a predetermined threshold.

The mechanical shock indicator assembly of this disclosure thus allows emergency medical technicians and other first arrivers at a vehicle accident to quickly assess whether the vehicle safety seat and its occupant have been subjected to a mechanical shock above a predetermined threshold, selected as potentially indicative of a trauma-producing event. This in turn can result in more timely critical medical attention for the vehicle's smaller passengers, even when there are no other immediate indications of potential trauma, i.e. beyond the indication of the mechanical shock indication assembly of this disclosure.

The details of one or more implementations of this disclosure are set forth in the accompanying drawings and the description below. Other features, objects, and advantages of the disclosure will be apparent from the description and drawings, and from the claims.

### DESCRIPTION OF DRAWINGS

FIGS. 1A and 1B are perspective views of typical vehicle safety seats for an infant and for a relatively older child, respectively, each with a mechanical shock indicator assembly of this disclosure mounted thereto.

FIG. 2 is a perspective view of a mechanical shock indicator assembly of this disclosure, e.g. as seen in FIG. 1;

FIGS. 3A and 3B are front plan and rear plan views, respectively, of the mechanical shock indicator assembly of FIG. 2;

FIG. 4 is a side plan view of the mechanical shock indicator assembly of FIG. 2;

FIG. 5 is an end plan view of the mechanical shock indicator assembly of FIG. 2;

FIG. 6 is an exploded assembly view of the mechanical shock indicator assembly of FIG. 2;

FIGS. 7, 7A, 7B, 7C, 7D, 7E, and 7F are perspective front view, perspective rear view, top plan view, end view, side view, section view, and detail section view, respectively, of the first, front body portion of the mechanical shock indicator assembly body of FIG. 2;

FIGS. 8, 8A, 8B, 8C, 8D, 8E, and 8F are front perspective view, front plan view, rear plan view, side view, end view, first section view, and detail section view, respectively of the second, rear body portion of the mechanical shock indicator assembly body of FIG. 2; and

FIG. 9, 9A, and 9B are top plan, end, and perspective views, respectively of the mechanical shock indicator of the mechanical shock indicator assembly of FIG. 2

Like reference symbols in the various drawings indicate like elements.

### DETAILED DESCRIPTION

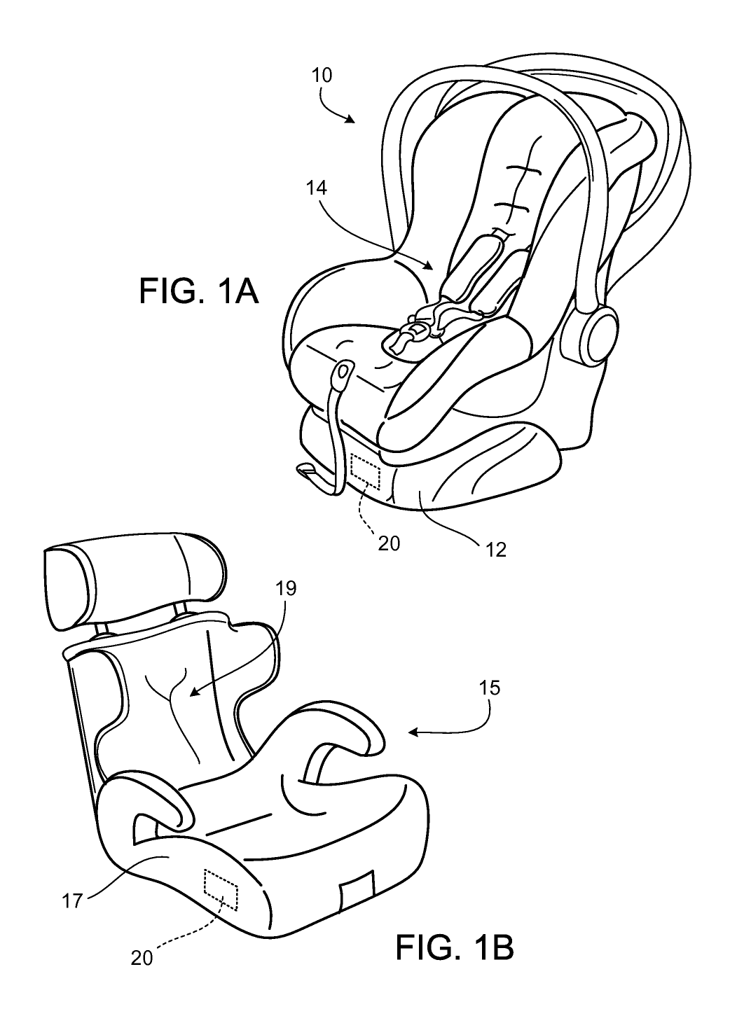

Referring to FIGS. 1A and 1B, typical vehicle safety seats 10, 15, respectively dimensioned, e.g., for an infant and for a relatively older child. Each safety seat 10, 15 has a safety seat body 12, 17 defining a seating region 14, 19 for the occupant. A mechanical shock indicator assembly 20 is mounted to the seat body 12, 17 for indication that the child vehicle safety seat 10, 15, and its occupant, have suffered a mechanical shock of a least a predetermined threshold magnitude, e.g. 50 G (where “G” represents a unit of acceleration equal to the standard acceleration of gravity, i.e. 32.1740 feet (or 9.80665 meters) per second per second, and “50 G” represents fifty times the standard acceleration of gravity), or other magnitude, or magnitudes, that may be deemed appropriate.

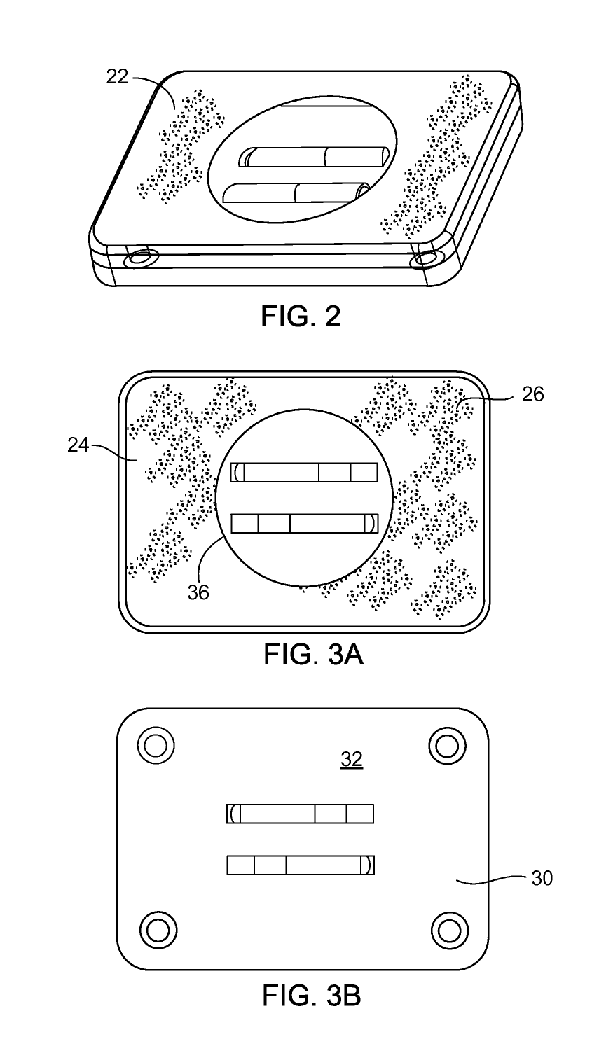

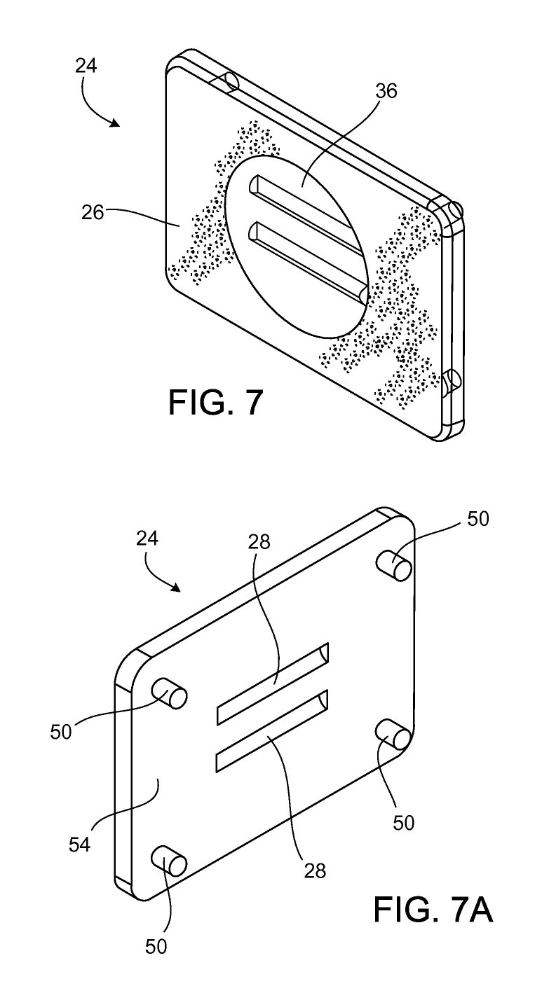

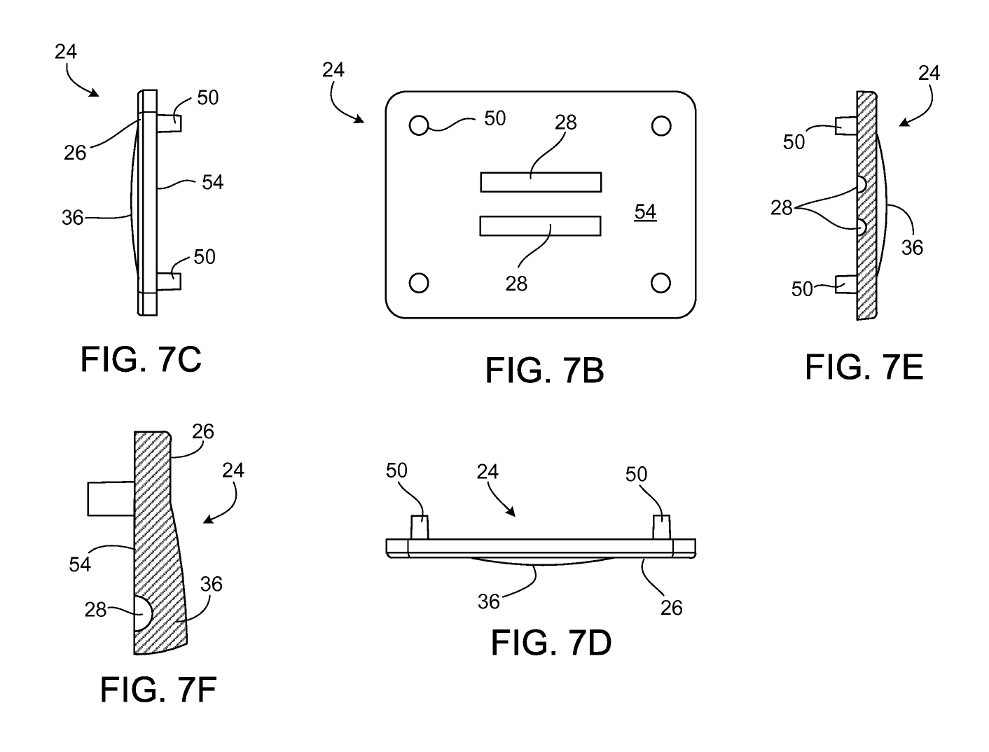

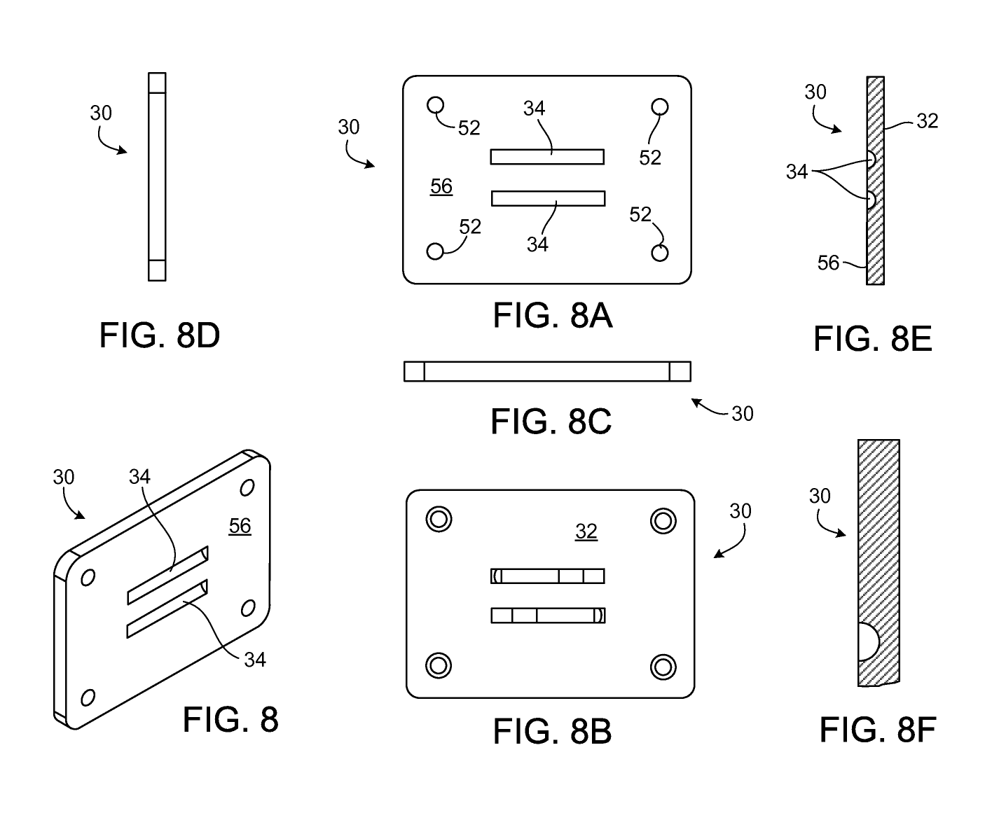

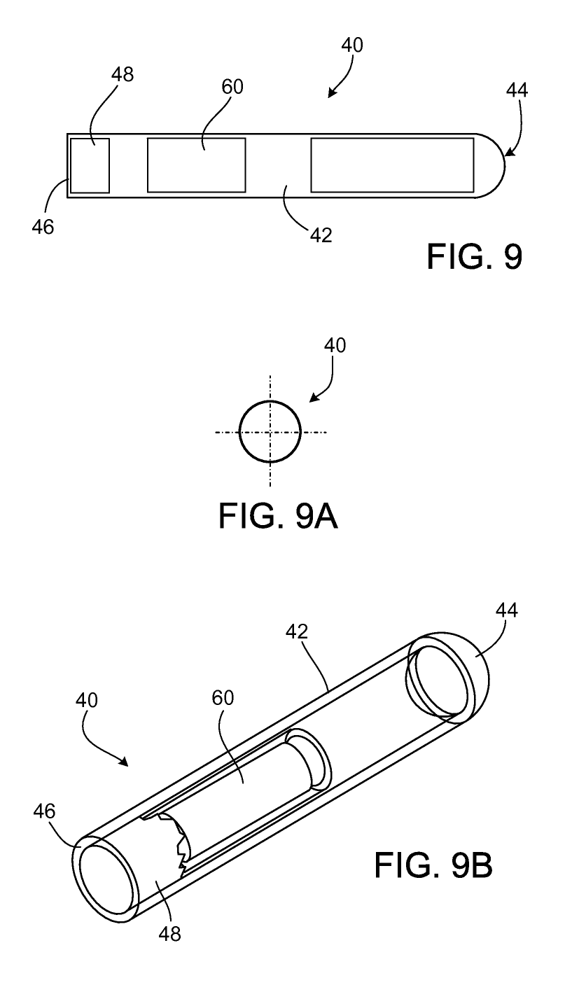

Referring next to FIGS. 2 through 6, 7A through 7F, 8A through 8F, and 9 through 9B, the mechanical shock indicator assembly 20 has an indicator assembly body 22 consisting of a front body portion 24 and a rear body portion 26, each formed of suitable molded plastic, e.g. acrylic. The front body portion 24 defines a front surface 26 of the indicator assembly body 22, and, in an opposite surface 27, defines first recess portions 28. The rear body portion 30 defines a rear surface 32 of the indicator assembly body 22, and, in the opposite surface 32, defines second recess portions 34. According to one implementation, the first and second recess portions 28, 34, defined, respectively, by the front body portion 24 and the rear body portion 30, cooperatively define two recesses sized for receiving mechanical shock indicators 40 (described more fully below with reference to FIGS. 9 through 9B), disposed in secure engagement therebetween.

The front body portion 24 further defines a transparent magnifier lens 36 overlying the mechanical shock indicators 40 disposed in the cooperating recesses 28, 34. The magnifier lens 36 facilitates visual assessment of the mechanical shock indicators 40 for indication that the mechanical shock indicator assembly, as well the vehicle safety seat 10, 15 and its occupant, have received a mechanical shock of at least the predetermined threshold magnitude. The front surface 26 is preferably textured about the magnifying lens, e.g. for improved viewing of the mechanical shock indicators 40.

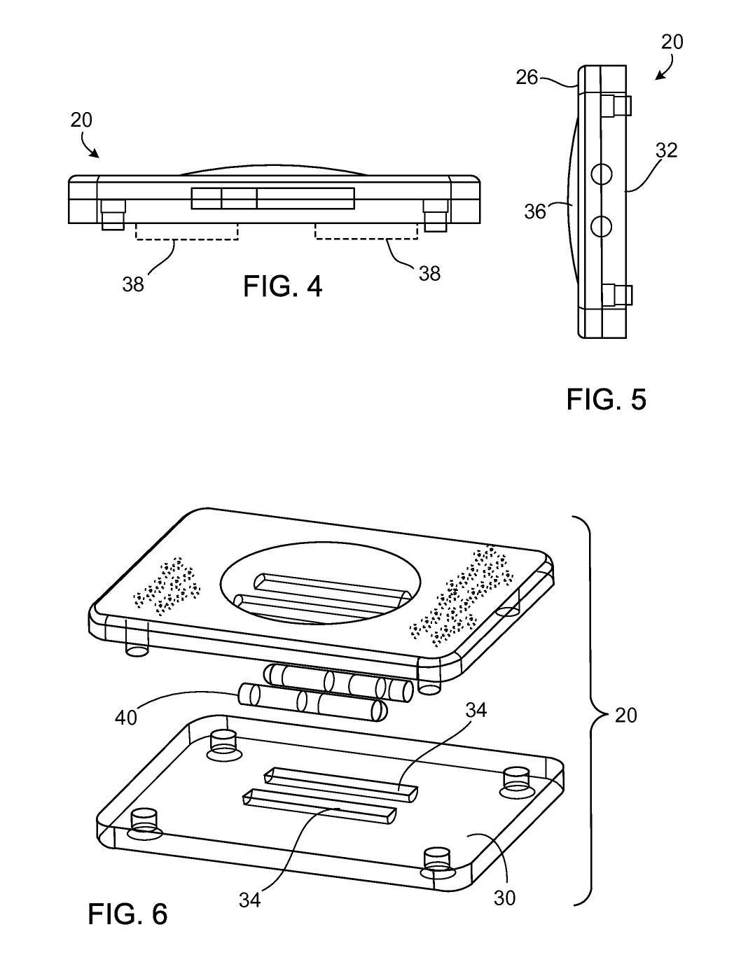

Referring next to FIG. 4, adhesive elements 38 are attached upon the rear surface 32 of the indicator assembly body 22 for mounting the mechanical shock indicator assembly 20 upon the safety seat body 12, 17.

Mechanical shock indicator elements 40, such as described above, are available commercially, e.g. from ShockWatch, of Dallas, Tex. (www.shockwatch.com). Briefly, with reference to FIGS. 9 through 9B, in preferred implementations, the mechanical shock indicator element 40 has the form of a tube 42 (approximately 0.675 inch in length and 0.095 inch in diameter), with a rounded tip end 44 (approximately 0.048 inch in radius) and an open end 46 sealed with a plug 48. The tube 42 is filled with a red liquid 60 held in suspension, e.g. by surface tension. When the mechanical shock indicator element 40 is subjected to an impact exceeding a specified G-level, e.g. 50 G., the shock (or acceleration) disrupts the surface tension of the liquid, releasing a highly visible red dye into the length of the tube 42. Thus there is created a permanent and immediate record that the mechanical shock indicator element has been subjected to a mechanical shock above a predetermined threshold, and once the device has been activated, it will not return to its original state. Further disclosure related to mechanical shock indicators can also be found, e.g., in Rubey U.S. Pat. Nos. 4,068,613 and 4,519,867, the complete disclosures of which are incorporated herein by reference.

The mechanical shock indicator assembly 20 for a vehicle safety seat 10, 15, e.g. suitable for an infant or for a relatively older child, respectively, may be assembled by the following method. Molded plastic front and rear body portions 24, 30 of an indicator assembly body 22 are provided. Mechanical shock indicators 40 are positioned in appropriately-sized recesses 28, 34 cooperatively defined by front and second rear indicator body portions 24, 30. The body portions 24, 30 are thereafter assembled, e.g., by engagement of cooperating pins 50 and apertures 52 provided for this purpose on the opposed inner surfaces 54, 56, of the front and rear body portions of the indicator assembly body 22, with the mechanical shock indicators 40 securely disposed within recesses, beneath the transparent magnifier lens 36 defined by the front body portion 24. The front and rear body portions 24, 30 are secured together with adhesive or ultra-sonic welding

The mechanical shock indicator assembly 20 is thereafter mounted to the seat body 12, 17 of a vehicle safety seat 10, 15, e.g., by mean of the adhesive elements 38 provided for the purpose on the rear surface 32 of the indicator assembly body 22.

In use, if a vehicle carrying one or more occupants in vehicle safety seats is involved in a collision or other traffic accident, emergency medical personnel arriving on the scene can quickly inspect the vehicle safety seats to determine whether a mechanical shock indicator assembly 20 is mounted upon the body of the vehicle child safety seat. If the vehicle safety seat is equipped with a mechanical shock indicator assembly 20 of this disclosure, it can quickly be located, and the mechanical shock indicators 40 contained within the mechanical shock indicator assembly 20 can be inspected visually through the magnifier lens 36 of the front body portion 24 of the indicator body 22. In this manner, the emergency personnel can quickly determine whether the vehicle safety seat, and its occupant, have been subjected to a mechanical shock above a predetermined threshold magnitude having a potential for trauma, even where that seat occupants may not have visible indication that a trauma may have occurred. As a result, appropriate precautions can be taken on a timely basis.

A number of implementations of this disclosure have been described. Nevertheless, it will be understood that various modifications may be made without departing from the spirit and scope of the invention. For example, the mechanical shock indicator assembly 20 may be removably mounted to the vehicle seat body, e.g. for permitting replacement or upgrades. Accordingly, other implementations are within the scope of the following claims.

What is claimed is:

1. A vehicle safety seat with mechanical shock indication, comprising:
a safety seat body defining a seat region for receiving and securely retaining a child during vehicle travel, and
a mechanical shock indicator assembly mounted to the safety seat body for indication that the child vehicle safety seat has suffered a mechanical shock of a least a predetermined magnitude,
the mechanical shock indicator assembly comprising:
an indicator body comprising a front body portion and a rear body portion, each of the body portions formed of molded plastic and defining a front surface and a rear surface of the indicator body, respectively,
the front body portion and the rear body portion cooperatively defining at least one recess sized for receiving a mechanical shock indicator in secure engagement therebetween,
at least one mechanical shock indicator element securely contained within the recess cooperatively defined by the front body portion and the rear body portion, and
the front body portion further defining a magnifier lens overlying the at least one mechanical shock indicator in the at least one recess, for facilitating assessment of the mechanical shock indicator for indication that the device has received a mechanical shock of at least the predetermined threshold magnitude.

2. The vehicle safety seat with mechanical shock indication of claim 1, wherein molded plastic forming the indicator body comprises acrylic.

3. The vehicle safety seat with mechanical shock indication of claim 1, wherein the predetermined magnitude of mechanical shock indicated by the at least one mechanical shock indicator is 50 G.

4. The vehicle safety seat with mechanical shock indication of claim 1, wherein the mechanical shock indicator assembly comprises at least two mechanical shock indicator elements, with the magnifier lens overlying the at least two mechanical shock indicator elements.

5. The child vehicle safety seat with mechanical shock indication of claim 4, wherein the front body portion and the rear body portion cooperatively define at least two recesses, each said recess containing a mechanical shock indicator element.

6. The child vehicle safety seat with mechanical shock indication of claim 1, further comprising one or more adhesive elements engaged between the rear surface of the indicator body and the safety seat body for mounting the mechanical shock indicator assembly upon the safety seat body.

7. A mechanical shock indicator assembly for a vehicle safety seat, comprising:
an indicator body comprising a front body portion and a rear body portion, each of the body portions formed of molded plastic and defining a front surface and a rear surface of the indicator body, respectively,
the front body portion and the rear body portion cooperatively defining at least one recess sized for receiving a mechanical shock indicator in secure engagement therebetween,
at least one mechanical shock indicator element securely contained within the recess cooperatively defined by the front body portion and the rear body portion,
the front body portion further defining a magnifier lens overlying the at least one mechanical shock indicator in the at least one recess, for facilitating assessment of the mechanical shock indicator for indication the device having received a mechanical shock of at least the predetermined value, and
one or more mounting elements adapted for mounting the mechanical shock indicator assembly upon a safety seat body of the vehicle safety seat.

8. The mechanical shock indication assembly for a vehicle safety seat of claim 7, further comprising one or more adhesive elements disposed for engagement between the rear surface of the indicator body and the safety seat body for mounting the mechanical shock indicator assembly upon the safety seat body.

9. The mechanical shock indication assembly for a vehicle safety seat of claim 8, wherein the one or more mounting elements comprise protective release elements removable to expose an adhesive surface.

10. A method of assembling a mechanical shock indicator assembly for a vehicle safety seat, the method comprising the steps of:
providing a front indicator body portion and a rear indicator body portion, each of the body portions being formed of molded plastic,
providing at least one mechanical shock indicator,
assembling the body portions with the at least one mechanical shock indicator positioned in an appropriately-sized recess cooperatively defined by body portions, and
securing the body portions together, with the mechanical shock indicator securely disposed within the at least one cooperatively sized recess, beneath a magnifier defined by the front body portion.

11. The method of assembling a mechanical shock indicator assembly for a vehicle safety seat of claim 10, the method comprising the further step of:
mounting the mechanical shock indicator assembly upon a safety seat body of a vehicle safety seat.

12. A method of assessing a vehicle safety seat for indication of experience of a mechanical shock above a predetermined threshold, the method comprising the steps of:
following a traffic accident involving a vehicle with one or more occupants in vehicle safety seats, inspecting the vehicle child safety seats for a mechanical shock indicator assembly mounted upon a seat body of the vehicle child safety seat, and,
upon locating the mechanical shock indicator assembly, inspecting an associated mechanical shock indicator through a magnifier lens disposed thereon for visual indication of a mechanical shock above a predetermined threshold.
